(19) United States
(12) Patent Application Publication
(10) Pub. No.: US 2006/0198548 A1
(43) Pub. Date: Sep. 7, 2006

(54) Frame for speaker device and speaker device

(76) Inventors: Hiromitsu Sasaki, Yamagata (JP); Yutaka Moriyama, Yamagata (JP); Eiji Sakaguchi, Saitama (JP); Hidehito Oki, Saitama (JP)

Correspondence Address: YOUNG & THOMPSON, 745 SOUTH 23RD STREET, 2ND FLOOR, ARLINGTON, VA, 22202, US

(21) Appl. No.: 11/356,168

(22) Filed: Feb. 17, 2006

(30) Foreign Application Priority Data
Feb. 17, 2005 (JP) 2005-040049

(51) Int. Cl. H04R 9/06

(52) U.S. Cl. 381/396

(57) ABSTRACT

A frame for a speaker device includes a magnetic circuit housing unit including an outer peripheral wall housing a magnetic circuit. The outer peripheral wall is formed into a streamline and curved shape.

### BACKGROUND OF THE INVENTION

1. Field of the Invention

The present invention relates to a configuration of a frame for a speaker device.

2. Description of Related Art

Conventionally, there is known a speaker device including a vibrating system having a frame and a diaphragm, and a magnetic circuit system having a yoke, a magnet and a plate.

In such a speaker device, the frame is formed into a bowl shape, for example. The frame having such a shape includes a magnetic circuit housing unit holding a magnetic circuit, an outer peripheral portion disposed on an outer side of the magnetic circuit housing unit and having an edge mounting portion on which an outer peripheral portion of an edge is mounted, and plural arm portions connecting the magnetic circuit housing unit and the outer peripheral portion.

Particularly, in the frame having such a configuration, a bottom surface having flatness is formed at a position on a rear side of the magnetic circuit housing unit, which the magnetic circuit is fixed to. The frame having such a configuration is disclosed in Japanese Patent Application Laid-open under No. 2001-352590, for example.

In addition, on the frame having the configuration of this kind, an opening is sometimes provided on a rear side of the frame in order to enhance radiation effect of heat generated in a voice coil (see Japanese Patent Application Laid-open under No. 2000-350287, for example).

There is known a speaker system formed by spatially connecting an inner portion of a speaker unit and an outer portion of an enclosure in order to reduce turbulence of an air flow (see Japanese Patent Application Laid-open under No. 2003-32774, for example). In addition, there is known a speaker device to which a waterproof cover including a magnet cover surrounding a magnet, a frame cover surrounding a frame, a first opening portion positioned between the magnet and the magnet cover and a second opening portion positioned between the magnet cover and the frame cover is applied (see Japanese Patent Application Laid-open under No. 11-285088, for example). Thereby, such a probability that drops of water entering an inner portion of a door fall to the speaker can be lowered. At the same time, such a probability that the air pressure on the rear side of the speaker becomes high and the movement of the diaphragm is prevented can be lowered.

On the frame according to the above-mentioned speaker device, the bottom surface for fixing the magnetic circuit on the rear side of the magnetic circuit housing unit structurally has flatness. Therefore, an air resistance in the vicinity of the bottom surface of the magnetic circuit housing unit becomes large when the air existing on the rear side of the speaker device flows to the side of the diaphragm.

Therefore, at the time of driving of the speaker device, when the air existing on the rear side of the speaker device moves to the direction of the diaphragm, a part of the air flows in such a manner that it collides with the bottom surface to rebound. Thus, the turbulence occurs to the air flow in the vicinity of the bottom surface. Thereby, the smooth movement of the diaphragm is mainly prevented, and there may occur such a problem that the performance of the speaker device deteriorates. In addition, at the time of the driving of the speaker device, the air on the rear side of the speaker device heated due to the temperature rise of the magnetic circuit accumulates in the vicinity of the bottom surface, and there may occur such a problem that the performance of the speaker device deteriorates.

### SUMMARY OF THE INVENTION

The present invention has been achieved in order to solve the above problems. It is an object of this invention to provide a frame for a speaker device and a speaker device using the frame capable of reducing turbulences of an air flow on a rear side of the speaker device and preventing a performance of the speaker device from deteriorating by mainly contriving a shape of an outer peripheral wall of a magnetic circuit housing unit.

According to an aspect of the present invention, there is provided a frame for a speaker device including a magnetic circuit housing unit including an outer peripheral wall housing a magnetic circuit, wherein the outer peripheral wall is formed into a streamline and curved shape.

The above frame for the speaker device structurally includes the magnetic circuit housing unit having the outer peripheral wall housing the magnetic circuit. Particularly, the outer peripheral wall of the magnetic circuit housing unit is formed into the streamline and curved shape. In a preferred example, a sectional shape of the outer peripheral wall may be formed into a substantial bowl shape.

Thereby, an air resistance in the vicinity of the outer peripheral wall of the magnetic circuit housing unit can be reduced when the air existing on the rear side of the speaker device flows to the side of the diaphragm. Therefore, in the speaker device using the frame for the speaker device, at the time of the driving, the air existing on the rear side of the speaker device can easily flow to the side of the diaphragm. Thereby, it can be reduced that turbulence occurs to the air flow on the rear side of the speaker device, i.e., in the vicinity of the lower surface of the outer peripheral wall of the magnetic circuit housing unit. Therefore, the diaphragm can be smoothly moved. As a result, it can be prevented that such a problem that the performance of the speaker device and the sound quality deteriorate occurs.

In a manner of the above frame for the speaker device, plural cut-out portions may be provided on the outer peripheral wall. In a preferred example, each of the cut-out portions may be provided at a position dividing the outer peripheral wall into equal parts.

Thereby, a contact area of the magnetic circuit and the cooled fresh external air increases, and the heat is easily and actively exchanged between the heated magnetic circuit and the cooled fresh external air. As a result, it becomes possible to improve a heat radiation property in the vicinity of the magnetic circuit on the rear side of the frame. Thereby, it can be prevented that such a problem that the performance of the speaker device and the sound quality deteriorate occurs.

According to another aspect of the present invention, there is provided a speaker device including a frame, the frame including a magnetic circuit housing unit including an outer peripheral wall housing a magnetic circuit, wherein the outer peripheral wall is formed into a streamline and curved shape.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 shows a perspective view of a speaker device according to an embodiment of the present invention when observed from a sound output side;

FIG. 2 shows a perspective view of the speaker device according to this embodiment when observed from a side opposite to the sound output side;

FIG. 3 shows a front view of the speaker device according to this embodiment;

FIG. 4 shows a rear view of the speaker device according to this embodiment;

FIG. 5 shows a one-side sectional view and a one-side side view of the speaker device according to this embodiment;

FIG. 6 shows a front view of a frame according to the embodiment of the present invention;

FIG. 7 shows a rear view of the frame according to the embodiment of the present invention;

FIG. 8 shows a sectional view taken along a cutting-plane line B-B′ of the frame in FIG. 6; and

FIG. 9 shows a sectional view of a frame according to a comparative example.

### DETAILED DESCRIPTION OF THE PREFERRED EMBODIMENTS

The preferred embodiments of the present invention will now be described below with reference to the attached drawings. In this embodiment, by forming the outer peripheral wall of the magnetic circuit housing unit being a component of a frame 1 into the streamline and curved shape, at the time of the driving of the speaker device, the occurrence of the turbulence to the air flow on the rear side of the frame is decreased. In addition, by providing the plural cut-out portions on the outer peripheral wall of the magnetic circuit housing unit, the heat radiation property in the vicinity of the magnetic circuit system is improved. Thereby, deterioration of the sound quality is prevented.

[Configuration of Speaker Device]

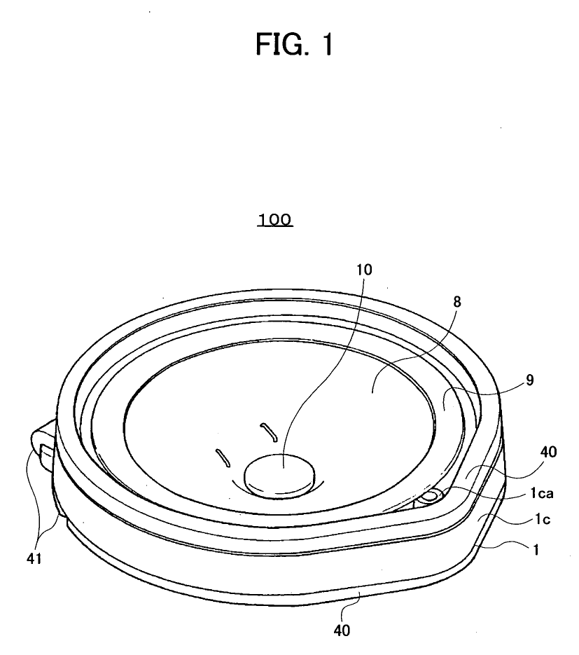

First, a description will be given of a configuration of a speaker device 100 according to an embodiment of the present invention with reference to FIG. 1 to FIG. 5.

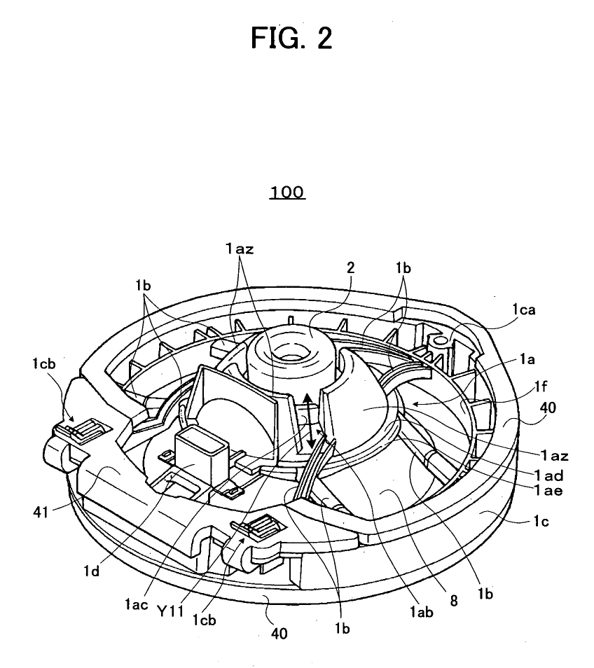

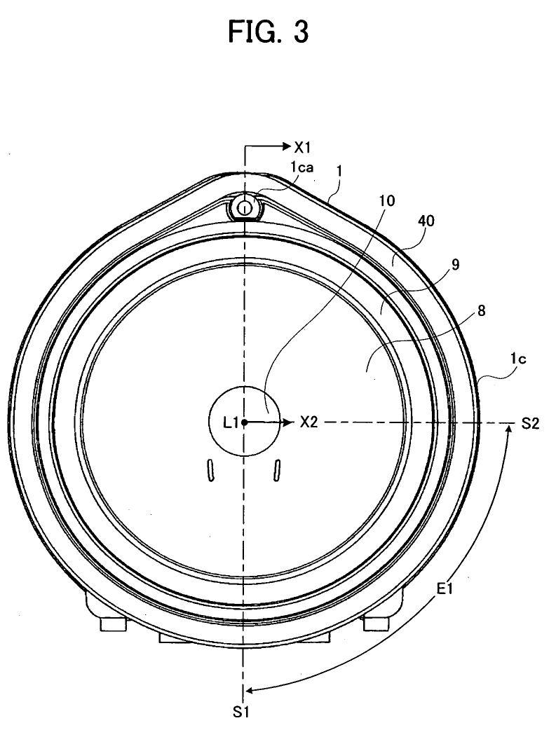

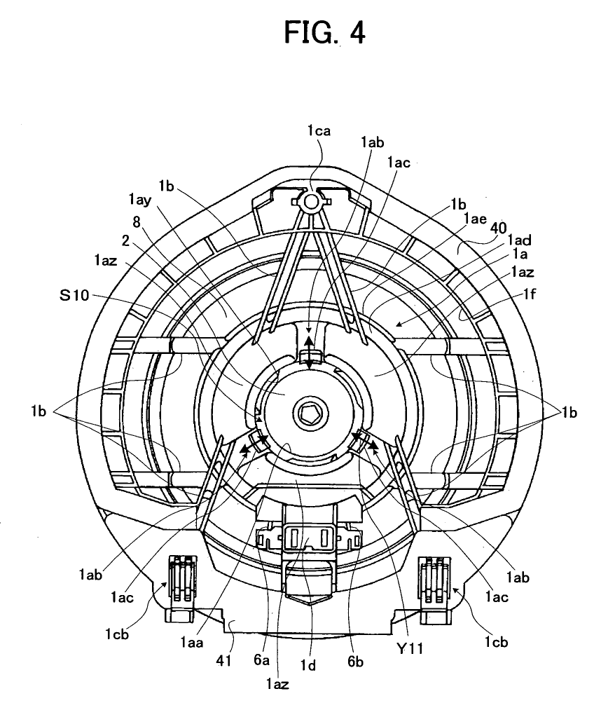

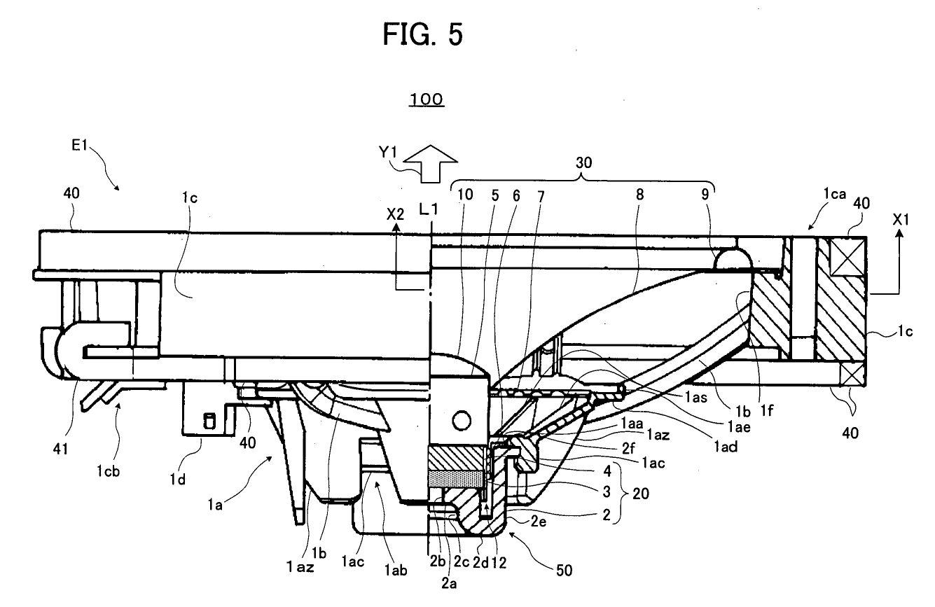

FIG. 1 shows a perspective view of the speaker device 100 according to an embodiment of the present invention in a case that it is observed from its sound output side. FIG. 2 shows a perspective view of the speaker device 100 in a case that it is observed from a side opposite to the sound output side, i.e., from a rear side. FIG. 3 shows a front view of the speaker device 100 in the case that it is observed from the sound output side. FIG. 4 shows a rear view of the speaker device 100 in the case that it is observed from the side opposite to the sound output side, i.e., from the rear side. FIG. 5 shows a sectional view of the speaker device 100 on the right side of the drawing with respect to a central axis L1 of the speaker device 100 (or the frame 1) and a side view of the speaker device 100 on the left side of the drawing with respect to the central axis L1, respectively. In addition, the sectional view shown on the right side of FIG. 5 is a sectional view taken along the cutting-plane line X1-X2 of the speaker device 100 shown in FIG. 3. The side view shown on the left side of FIG. 5 corresponds to a side surface portion E1 of the speaker device 100 between a plane surface S1 passing through the central axis L1 of the speaker device 100 and a plane surface S2 passing through the central axis L1 and perpendicular to the plane surface S1 in FIG. 3.

The speaker device 100 according to this embodiment can be preferably used as an on-vehicle speaker device. The speaker device 100 is configured by mounting a speaker unit 50 onto the frame 1.

The speaker unit 50 includes a magnetic circuit system 20 having a yoke 2, a magnet 3 and a plate 4, and a vibrating system 30 having a voice coil bobbin 5, a voice coil 6, a damper 7, a diaphragm 8, an edge 9 and a cap 10.

First, each component of the magnetic circuit system 20 will be explained.

The magnetic circuit system 20 is configured as an internal magnet type magnetic circuit.

The yoke 2 is formed into a substantial pot shape. The yoke 2 has a first flat portion 2a for supporting a disc-shape magnet 3, an opening 2b formed at a substantial center of the first flat portion 2a, a first cylindrical portion 2c connected to an outer peripheral portion of the first flat portion 2a, a second flat portion 2d connected to a lower end portion of the first cylindrical portion 2c, a second cylindrical portion 2e connected to an outer peripheral portion of the second flat portion 2d and a flange portion 2f connected to an upper end portion of the second cylindrical portion 2e and outwardly extending from the upper end portion. Each of the components is integrally formed.

An upper surface of the first flat portion 2a has flatness. The opening 2b has a function of radiating a heat generated in the magnetic circuit system 20 to the outside. The first cylindrical portion 2c is formed into a cylindrical shape. In FIG. 5, by forming the first cylindrical portion 2c to have a predetermined length in the direction of an arrow Y1, a relative positional relation of components of the vibrating system 30 with respect to the magnet 3 and the plate 4 can be adjusted. A lower surface of the second flat portion 2d has flatness. The second flat portion 2d has a function of forming a constant gap between the first cylindrical portion 2c and the second cylindrical portion 2e. The second cylindrical portion 2e is formed into a cylindrical shape and is provided on the outer side of the first cylindrical portion 2c. The second cylindrical portion 2e has a function of forming a magnetic gap 12 between an inner peripheral wall of the second cylindrical portion 2e and each of the outer peripheral walls of the magnet 3 and the plate 4. The flange portion 2f is fixed to a magnetic circuit housing unit 1a being a component of the frame 1. By mounting the flange portion 2f onto the magnetic circuit housing unit 1a, the magnetic circuit system 20 can be housed in the magnetic circuit housing unit 1a.

The magnet 3 is formed into a disc shape and is mounted onto the first flat portion 2a of the yoke 2. On the magnet 3, the disc-shape plate 4 having the substantially same diameter as the magnet 3 is mounted.

In the magnetic circuit system 20 having such a configuration, the magnet 3 and the plate 4 configure the magnetic circuit, and magnetic flux of the magnet 3 is concentrated on the magnetic gap 12 formed between the outer peripheral wall of the plate 4 and the inner peripheral wall of the second cylindrical portion 2e.

Next, each component of the vibrating system 30 will be explained.

The voice coil bobbin 5 is formed into a substantially cylindrical shape. The voice coil 6 which will be explained later is wound around the vicinity of the lower end portion of the outer peripheral wall of the voice coil bobbin 5. The vicinity of the lower end portion of the inner peripheral wall of the voice coil bobbin 5 is opposite to each of the outer peripheral walls of the magnet 3 and the plate 4 with constant spaces therebetween. Meanwhile, the vicinity of the lower end portion of the outer peripheral wall of the voice coil bobbin 5 is opposite to the vicinity of the upper end portion of the inner peripheral wall of the second cylindrical portion 2e being the component of the yoke 2 with a constant space therebetween. A gap (magnetic gap 12) is formed between the inner peripheral wall of the second cylindrical portion 2e and the outer peripheral wall of the plate 4.

The voice coil 6 has one wiring, which includes a plus lead wire 6a and a minus lead wire 6b as shown in FIG. 4. The plus lead wire 6a is an input wiring for an L (or R)-channel signal, and the minus leadwire 6b is an input wiring for a ground (GND: ground) signal. The lead wires 6a and 6b are electrically connected to a terminal 1d provided on the frame 1. In addition, the terminal 1d is electrically connected to a wiring on an output side of an amplifier (not shown). Thereby, the signal and the power of one channel are inputted to the voice coil 6 from the amplifier side via the terminal 1d and the lead wires 6a and 6b.

The damper 7 is formed into an annular shape and has an elastic portion on which corrugations are concentrically formed. An inner peripheral edge portion of the damper 7 is mounted onto the vicinity of the upper end portion of the outer peripheral wall of the voice coil bobbin 5. Meanwhile, an outer peripheral edge portion of the damper 7 is mounted onto the outer peripheral portion of the magnetic circuit housing unit 1a.

Various kinds of materials such as paper, high polymer and metal can be applied to the diaphragm 8 in accordance with the various use purposes. The diaphragm 8 is formed into a cone shape. An inner peripheral edge portion of the diaphragm 8 is mounted onto the vicinity of the upper end portion of the outer peripheral wall of the voice coil bobbin 5 and onto the upper side of the damper 7. Meanwhile, the outer peripheral edge portion of the diaphragm 8 is mounted onto the inner peripheral edge portion of the annular edge 9. The outer peripheral edge portion of the edge 9 is mounted onto an outer peripheral portion 1c of the frame 1. In this example, the diaphragm 8 and the edge 9 are independently formed. However, this invention is not limited to this. Namely, the diaphragm 8 and the edge 9 may be integrally formed.

The cap 10 is formed into a substantial dome shape and is mounted onto the outer peripheral wall of the voice coil bobbin 5 in a manner to cover the upper surface of the voice coil bobbin 5. Thereby, it can be prevented that dust and foreign matter enter the inner side of the speaker unit 50.

The frame 1 is formed with various kinds of materials such as a metal and a resin. For the purpose of lightening the speaker device 100, the frame 1 is preferably formed with a resin material. The frame 1 mainly includes the magnetic circuit housing unit 1a, the outer peripheral portion 1c arranged on the outer side and the upper side of the magnetic circuit housing unit 1a, plural arm portions 1b connecting the magnetic circuit housing unit 1a and the outer peripheral portion 1c, and the terminal 1d provided in the vicinity of the outer peripheral portion of the magnetic circuit housing unit 1a. Each of the components is integrally formed. In addition, on the frame 1, an opening 1f is formed between the magnetic circuit housing unit 1a and the outer peripheral portion 1c.

The magnetic circuit housing unit 1a is formed into a substantial bowl shape and mainly has an opening 1aa, cut-out portions lab and plural fixing portions 1ac. The diameter of the opening 1aa is substantially same as an outside diameter of the second cylindrical portion 2e of the yoke 2. When the direction of the central axis L1 of the speaker device 100 is prescribed as the vertical direction in FIG. 5, the opening 1aa is formed at a position corresponding to the substantial center of the vertical direction of the magnetic circuit housing unit 1a. Each of the cut-out portions 1ab is formed by removing a part of the outer peripheral wall of the magnetic circuit housing unit 1a, and it is formed in the vicinity of the outer peripheral wall thereof with proper spaces therebetween. Each of the fixing portions 1ac is formed in the vicinity of the opening 1aa and at a position corresponding to the cut-out portion 1ab. In addition, each of the fixing portions 1ac is formed along the circumferential direction of the opening 1aa with proper spaces therebetween.

One end of each arm portion 1b is mounted onto the outer peripheral wall of the magnetic circuit housing unit 1a, and the other end thereof is attached to the inner peripheral wall of the outer peripheral portion 1c.

The outer peripheral portion 1c is formed into a substantially annular shape, and is provided on the outer side of the magnetic circuit housing unit 1a and the plural arm portions 1b. The outer peripheral portion of the edge 9 and cushion members 40 and 41 are mounted onto the outer peripheral portion 1c. The outer peripheral portion 1c has mounting portions 1ca and 1cb for mounting the speaker device 100 onto the mounting base such as an inner panel of the vehicle door, for example.

The mounting portion 1ca is an inserting hole into which a bolt is inserted, and is provided at the position opposite to the terminal 1d at the outer peripheral portion 1c. The mounting portions 1cb are formed into a claw shape, and they are provided at the position opposite to the mounting portion 1ca on the lower surface side of the outer peripheral portion 1c and in the vicinity of the terminal 1d. In addition, the one mounting portion 1cb and the other mounting portion 1cb are provided on the lower surface side of the outer peripheral portion 1c with a constant space therebetween.

To the upper surface of the outer peripheral portion 1c and a part of the lower surface of the outer peripheral portion 1c, a cushion member 40 having a cushion property and formed into a stick shape are attached in a state deformed into a substantial circle shape. As the cushion member 40, a member having an elastic property such as sponge and urethane is preferable, for example. In addition, to the other part of the lower surface of the outer peripheral portion 1c on the side of the plural mounting portions 1cb, a cushion member 41 formed with the same member as the cushion member 40 and formed into a shape shown in FIG. 5 is attached. Onto one surface of each of the cushion members 40 and 41, a seal having an adhesive property is printed or an adhesive is applied.

The above-mentioned speaker unit 50 is mounted onto the frame 1 in a manner which will be explained below. In FIG. 5, the voice coil bobbin 5 and the cap 10 being the components of the vibrating system 30 are inserted into the opening 1aa of the magnetic circuit housing unit 1a from the direction of the arrow Y1, and the upper end portion of the voice coil bobbin 5 and the cap 10 are disposed at the upper portion of the surface on the sound output side of the diaphragm 8. In this state, the flange portion 2f being the component of the yoke 2 is fixed to the plural fixing portions 1ac provided in the magnetic circuit housing unit 1a. In this manner, the speaker unit 50 is mounted onto an appropriate position of the frame 1, and the speaker device 100 is configured.

In the speaker device 100 having the above-mentioned configuration, the signal and power outputted from the amplifier are inputted to the voice coil 6 via the terminal 1d, and the lead wires 6a and 6b of the voice coil 6. Thereby, a driving force occurs to the voice coil 6 in the magnetic gap 12, which vibrates the diaphragm 8 in the direction of the central axis L1 of the speaker device 100 in FIG. 5. In this manner, the speaker device 100 emits an acoustic wave in the direction of the arrow Y1 shown in FIG. 5.

(Configuration of Frame)

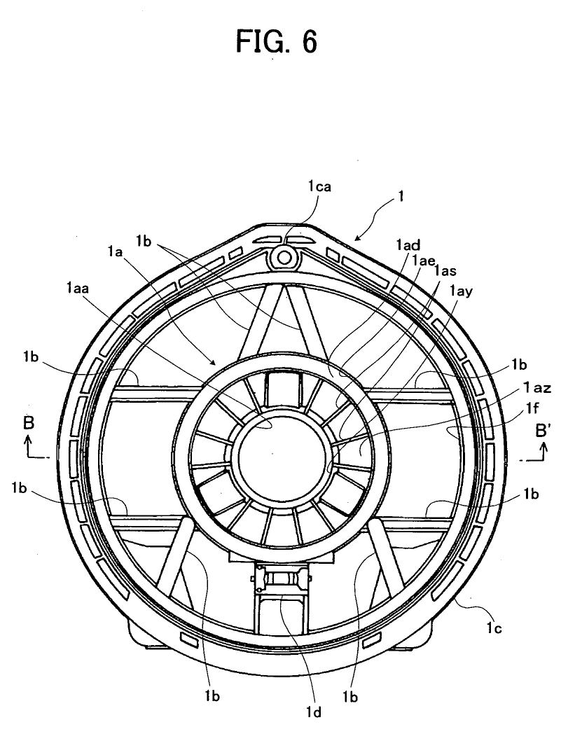

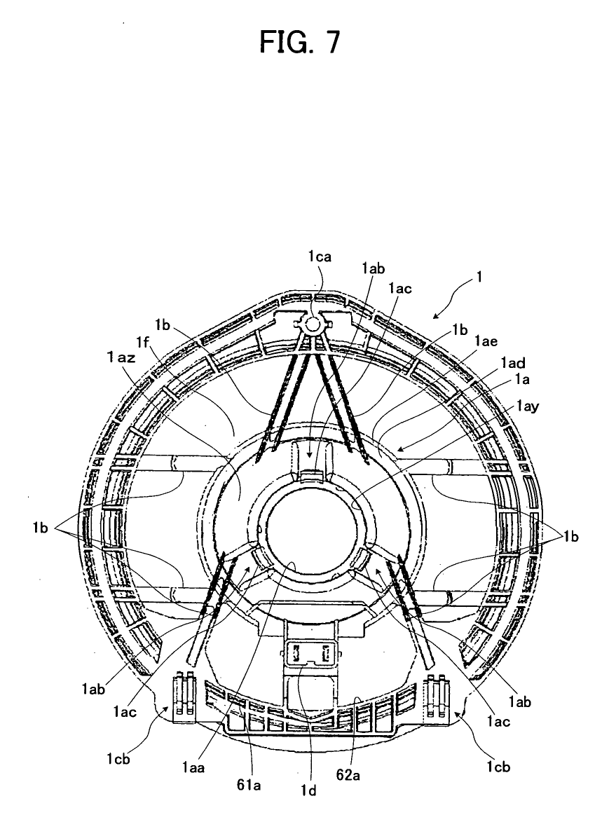

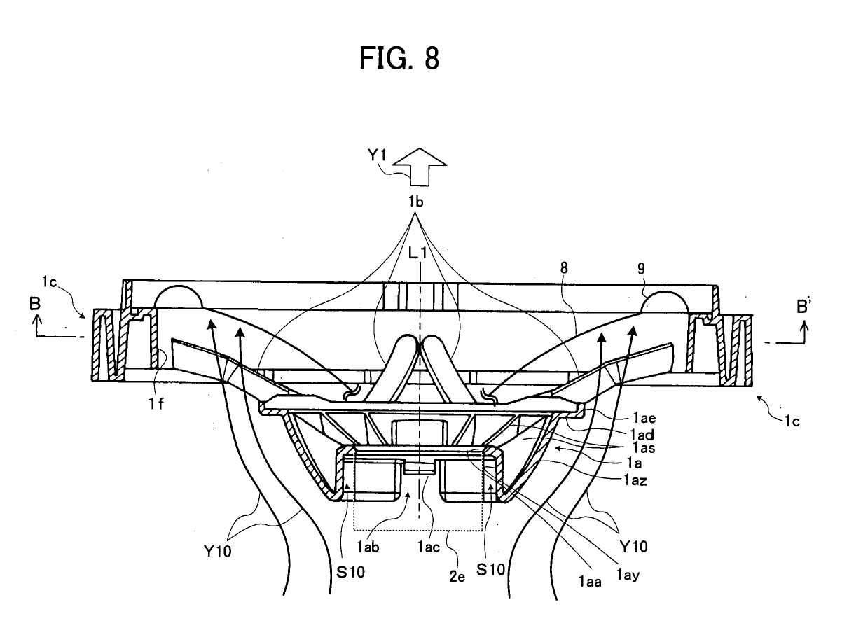

Next, a description will be given of the configuration of the frame 1 characterizing the present invention with reference to FIG. 6 to FIG. 8. FIG. 6 shows a front view of the frame. FIG. 7 shows a rear view of the frame. FIG. 8 shows a sectional view taken along a cutting line B-B′ of the frame 1 shown in FIG. 6. In FIG. 8, positions of the diaphragm 8 and the second cylindrical portion 2e (a part shown by a broken line) being the component of the yoke 2 are also shown for convenience of an explanation.

The basic configuration of the frame 1 is described above. Therefore, a description will be mainly given of the component of the frame 1 related to the present invention, specifically, the configuration of the magnetic circuit housing unit 1a, below. Particularly, the present invention is characterized by a shape of an outer peripheral wall 1az of the magnetic circuit housing unit 1a and by providing the cut-out portions 1ab on the outer peripheral wall 1az.

The magnetic circuit housing unit 1a includes a damper mounting portion 1ad formed into an annular shape, an annular rib 1ae upwardly projecting from an outer peripheral edge portion of an upper surface of the damper mounting portion 1ad, the outer peripheral wall 1az obliquely downwardly extending from an inner peripheral edge portion of a lower surface of the damper mounting portion 1ad in the direction of the central axis L1, an inner peripheral wall 1ay upwardly standing from the lower end of the outer peripheral wall 1az, the opening 1aa formed on the upper end side of the inner peripheral wall 1ay and plural reinforcement members 1as connecting the outer peripheral wall 1az and the inner peripheral wall 1ay, other than the above-mentioned components.

The outer peripheral edge portion of the damper 7 is mounted onto the upper surface of the damper mounting portion 1ad. The rib 1ae mainly has a function of positioning the damper 7 at an appropriate position on the damper mounting portion 1ad. The outer peripheral wall 1az is formed into the streamline and curved shape. In addition, the sectional shape of the outer peripheral wall 1az is formed into a substantial bowl shape. The plural cut-out portions 1ab formed by removing parts of the outer peripheral wall 1az are formed on the outer peripheral wall 1az. As shown in FIG. 7, the cut-out portions 1ab are provided at positions dividing the outer peripheral wall 1az of the magnetic circuit housing unit 1a into substantially three parts, respectively. Additionally, at positions corresponding to the cut-out portions 1ab, the fixing portions 1ac for fixing the flange portion 2f of the yoke 2 to the magnetic circuit housing unit 1a are provided. The inner peripheral wall 1ay is opposite to the outer peripheral wall of the second cylindrical portion 2e being the component of the yoke 2 with a constant space. The outer peripheral wall 1az and the inner peripheral wall 1ay are connected by the plural reinforcement members 1as formed into a paddle or substantial triangle shape. Thereby, the strength of the magnetic circuit hosing unit 1 is enhanced. A space S10 formed into a substantially annular shape is formed between the inner peripheral wall 1ay and the second cylindrical portion 2e being the component of the yoke 2.

The embodiment of the present invention having such a configuration has more advantageous operation and effect than a comparative example.

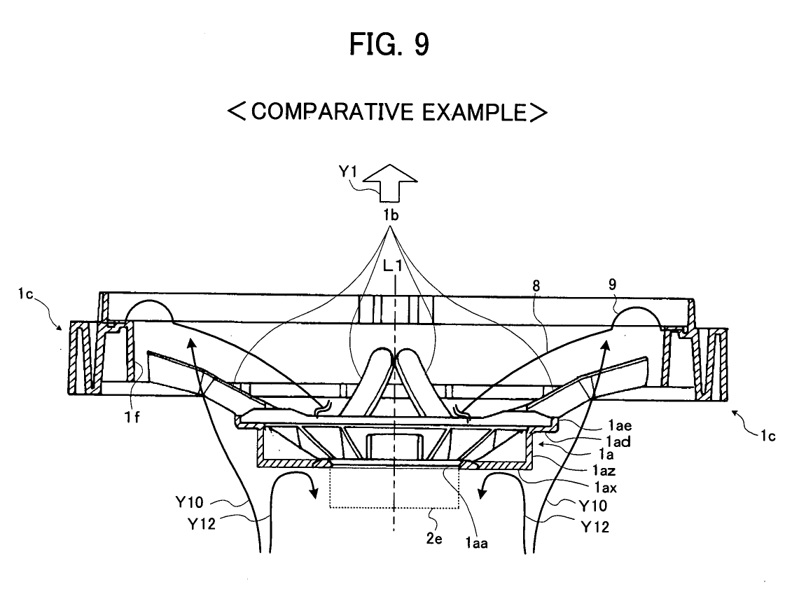

First, a configuration of the comparative example will be briefly described with reference to FIG. 9. FIG. 9 is a sectional view of the frame according to the comparative example corresponding to FIG. 8. In FIG. 9, for convenience of an explanation, the positions of the diaphragm 8 and the second cylindrical portion 2e (the part shown by the broken line) being the component of the yoke 2 are also shown. In addition, in FIG. 9, the same reference numerals are given to the same components as the present invention, and explanations thereof will be omitted or simplified.

When the comparative example and this embodiment are compared in FIG. 8 and FIG. 9, they are greatly different particularly in that the comparative example includes a bottom portion 1ax having flatness at the position to which the yoke 2 being the component of the magnetic circuit is fixed. Other components are substantially same.

Therefore, in the comparative example, an air resistance in the vicinity of the bottom portion 1ax becomes large when the air flows into the direction of the arrow Y1.

When the frame 1 having such a configuration is applied to the speaker device, at the time of the driving of the speaker device, the turbulence occurs to the air flow in the vicinity of the lower surface of the bottom portion 1ax positioned on the rear side of the frame 1. Namely, when the diaphragm 8 according to the comparative example is assumed to move in the direction of the arrow Y1 in FIG. 9, by suction force at the time of the movement of the diaphragm 8, the air existing on the rear side of the frame 1 flows along directions of arrows Y10 and Y12. Particularly, a part of the air existing on the rear side of the frame 1 flows along the direction of the arrow Y12, i.e., the part of the air flows in such a manner that it collides against the lower surface of the bottom portion 1ax to rebound. Thereby, the turbulence occurs to the air flow in the vicinity of the lower surface of the bottom portion 1ax. Thus, the smooth movement of the diaphragm 8 is mainly prevented, and the performance of the speaker device may be problematically deteriorated.

On the other hand, in the present invention, since the outer peripheral wall 1az of the magnetic circuit housing unit 1a is formed into the streamline and curved shape, the air resistance of the magnetic circuit housing unit 1a becomes small when the air flows in the direction of the arrow Y1. Therefore, in the speaker device 100 using the frame 1, at the time of the driving, the air existing on the rear side of the speaker device 100 easily flows to the diaphragm 8. Thereby, it can be reduced that the turbulence occurs to the air flow on the rear side of the speaker device 100, i.e., in the vicinity of the lower surface side of the outer peripheral wall 1az of the magnetic circuit housing unit 1a. Thus, in the present invention, there does not occur the above-mentioned problem caused in the comparative example.

This point will be explained with reference to FIG. 8. In the present invention, when the diaphragm 8 is assumed to move in the direction of the arrow Y1, by the suction force at the time of the movement of the diaphragm 8, the air existing on the rear side of the frame 1 flows along the direction of the arrow Y10.

Namely, in the present invention, the air existing on the rear side of the frame 1 does not flow in such a manner that the air collides against the bottom portion of the magnetic circuit housing unit 1a to rebound like the comparative example. This is because the outer peripheral wall 1az of the magnetic circuit housing unit 1a formed into the streamline and curved shape and no bottom portion included in the comparative example is formed in the magnetic circuit housing unit 1a of the present invention. Therefore, in the present invention, it can be prevented that the turbulence occurs to the air flow on the rear side of the frame 1 by the shape of the outer peripheral wall 1az of the magnetic circuit housing unit 1a. As a result, in the present invention, the diaphragm can be smoothly moved. Thereby, it can be prevented that the performance of the speaker device 100 and the sound quality problematically deteriorate.

In addition, in the present invention, the plural cut-out portions 1ab are provided on the outer peripheral wall 1az of the magnetic circuit housing unit 1a with appropriate spaces therebetween. In a preferred example, the plural cut-out portions 1ab may be provided at positions dividing the outer peripheral wall 1az of the magnetic circuit housing unit 1a into equal parts (substantially three equal parts in this example), respectively. Thereby, as shown by the arrow Y11 in FIG. 2 and FIG. 4, a contact area of the side wall of the second cylindrical portion 2e being the component of the yoke 2 and the cooled fresh external air increases, and the heat can be easily and actively exchanged between the side wall of the heated second cylindrical portion 2e and the cooled fresh external air. Namely, it can be prevented that the air in the space S10 heated with the temperature rise of the magnetic circuit system 20 stays in the space S10. Thereby, the heat radiation property in the vicinity of the yoke 2 on the rear side of the frame 1 can be improved. As a result, it can be prevented that the performance of the speaker device 100 and/or the sound quality problematically deteriorate.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2005-040049 filed on Feb. 17, 2005 including the specification, claims, drawings and summary is incorporated herein by reference in its entirety.

What is claimed is:

1. A frame for a speaker device comprising a magnetic circuit housing unit including an outer peripheral wall housing a magnetic circuit, wherein the outer peripheral wall is formed into a streamline and curved shape.

2. The frame for the speaker device according to claim 1, wherein a sectional shape of the outer peripheral wall is formed into a substantial bowl shape.

3. The frame for the speaker according to claim 1, wherein plural cut-out portions are provided on the outer peripheral wall.

4. The frame for the speaker device according to claim 3, wherein each of the cut-out portions is provided at a position dividing the outer peripheral wall into equal parts.

5. A speaker device comprising a frame, the frame comprising a magnetic circuit housing unit including an outer peripheral wall housing a magnetic circuit, wherein the outer peripheral wall is formed into a streamline and curved shape.
